(19) United States
(12) Patent Application Publication
(10) Pub. No.: US 2018/0143941 A1
(43) Pub. Date: May 24, 2018

(54) METHOD OF SOLVING STRESS BASED ON FORCE BOUNDARY AND BALANCE CONDITION

(71) Applicant: Hubei University of Technology, Wuhan (CN)

(72) Inventors: Yingfa Lu, Wuhan (CN); Defu Liu, Wuhan (CN); Yuan Yan, Wuhan (CN); Lai Zhan, Wuhan (CN)

(21) Appl. No.: 15/820,392

(22) Filed: Nov. 21, 2017

(30) Foreign Application Priority Data
Nov. 23, 2016 (CN) 201611034900.3

(51) Int. Cl. G06F 17/13

(52) U.S. Cl. CPC G06F 17/13

(57) ABSTRACT

A method of solving a stress based on force boundary and balance condition, the method including: 1) measuring a macro-geometric feature of a research object, and establishing a geometric feature description equation corresponding to the macro-geometric feature; 2) analyzing a specific gravity distribution feature of the research object, and establishing a specific gravity distribution equation of the research object in a research area; 3) analyzing a feature of boundary condition stress of the research object, and establishing a boundary condition stress equation corresponding to the feature of boundary condition stress; 4) selecting a stress expression equation satisfying corresponding balance equation and a boundary condition equation of a force; and 5) analyzing a stress feature of the research object in detail according to an existing strength criterion; and performing comparative analysis on a deformation feature of the research object, and determining a behavior feature of the research object.

### CROSS-REFERENCE TO RELATED APPLICATIONS

Pursuant to 35 U.S.C. § 119 and the Paris Convention Treaty, this application claims foreign priority to Chinese Patent Application No. 201611034900.3 filed Nov. 23, 2016, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

### Field of the Invention

The present disclosure relates to technical fields related to force and deformation such as mechanics, civil engineering and geological engineering, in particular to research and application of destruction process of different construction structures such as dams, bridges, slopes, roadbeds, houses, tunnels, inclusions, lanes and culverts. In the present disclosure, theoretical solving of a stress and strain is realized, which plays a significant role in promoting design, research, prediction and forecast and the like of dynamic-static loading/unloading and the like of different construction structures such as dams, bridges, slopes, roadbeds, houses, tunnels, inclusions, lanes and culverts.

### Description of the Related Art

Existing stress solving is often based on a numerical calculation method of a finite element and the like. A finite element method adopts a point to replace a surface (note: for a two-dimensional problem) or a body (note: for a three-dimensional problem), thus calculation results of the elements that are different in size are different; moreover, in a numerical calculation, a linear method is adopted to solve a nonlinear problem, i.e., initial stress method (or initial strain method); of course, different criteria may lead to different results. However, for a fixed-shape research object, the stress state thereof should also be determined; for this reason, the present disclosure proposes a method of solving a stress based on force boundary and balance condition, which acquires a theoretical solution of a stress by assuming that the stress satisfies the force boundary and the balance condition. The method will promote the existing method of solving a stress by a big leap forward.

### SUMMARY OF THE INVENTION

In view of the above-described problems, it is one objective of the invention to provide a method of solving a stress based on force boundary and balance condition. The method is based on a fixed-shape research object, a stress state corresponding to the research object should also be a determined fact, and a corresponding theoretical solution of a stress is acquired by assuming that the stress satisfies the force boundary and the balance condition. The method distinguishes the stress state of the research object from the boundary condition stress corresponding to the research object; and under the condition of a continuous stress, the vector sum of the boundary stress state of the research object and boundary condition stress corresponding to the research object is zero; and under the condition of a discontinuous stress, the vector sum of the above two is not zero. Reason of the discontinuous stress may be analyzed to calculate corresponding discontinuous deformation and discontinuous stress, and the discontinuous stress should enable the research object to satisfy the balance condition so that a stress distribution of the research object is obtained, and a calculation problem arising from the discontinuous stress is solved.

To achieve the above objective, in accordance with one embodiment of the invention, there is provided a method of solving a stress based on force boundary and balance condition, the method comprising:
1) measuring a macro-geometric feature of a research object, and establishing a geometric feature description equation corresponding to the macro-geometric feature;
2) analyzing a specific gravity distribution feature of the research object, and establishing a specific gravity distribution equation of the research object in a research area;
3) analyzing a feature of boundary condition stress of the research object, and establishing a boundary condition stress equation corresponding to the feature of boundary condition stress;
4) selecting a stress expression equation wherein the stress expression equation satisfies corresponding balance equation and a boundary condition equation of a force, and all constant coefficients are calculated; and
5) analyzing a stress feature of the research object in detail according to an existing strength criterion; and performing comparative analysis on a deformation feature of the research object, and determining a behavior feature of the research object according to corresponding constitutive equation.

In a class of this embodiment, a corresponding geometric feature description equation is established based on accurate measurement and research of the research object in 1), wherein the geometric feature description equation comprises a linear equation or a nonlinear equation, the linear equation is represented as y=kx+b and the nonlinear equation comprises a curve equation;

the specific gravity distribution equation of the research object in the research area is established based on the research of the specific gravity distribution feature of the research object in 2), wherein a specific gravity corresponding to the specific gravity distribution equation comprises γ_{w,x}, γ_{w,y}, γ_{w,z};

a corresponding boundary stress equation is established based on feature research of boundary condition stress of the research object, in 3); wherein when the research object is a two-dimensional geometric configuration, in case that AB is a boundary surface, a normal stress of the boundary condition of an AB surface is σ_{N}^{AB,B}, a shear stress of the boundary condition of the AB surface is τ_{N}^{AB,B}, and a mathematical relational expression below is satisfied:

σ_{N}^{AB,B}=l²σₓₓ^{AB}+m²σ_{yy}^{AB}+2lmτ_{xy}^{AB} (1)

τ_{N}^{AB,B}=lm(σ_{yy}^{AB}−σₓₓ^{AB})+(l²−m²)τ_{xy}^{AB} (2)

in formula (1) and formula (2), l and m are cosine values in an outer normal direction of the AB surface; σₓₓ^{AB} and σ_{yy}^{AB} are normal stresses and τ_{xy}^{AB} is a shear stress;

a stress expression equation is selected in 4) wherein the stress expression equation satisfies corresponding balance equation of a force and a corresponding boundary condition equation of a force, and each of corresponding constant coefficients is thus solved;

when the research object is a two-dimensional geometric configuration, a stress comprises normal stresses σₓₓ and σ_{yy} and shear stress τ_{xy}; when an expression of the stress satisfies a mathematical relational expression below:

σₓₓ=a_{1,1}x+a_{1,2}y+a_{1,3}x²+a_{1,4}xy+a_{1,5}y²+a_{1,6}x³+a_{1,7}x²y+a_{1,8}xy²+. . . (3)

σ_{yy}=a_{2,1}x+a_{2,2}y+a_{2,3}x²+a_{2,4}xy+a_{2,5}y²+a_{2,6}x³+a_{2,7}x²y+a_{2,8}xy²+. . . (4)

τ_{xy}=a_{3,1}x+a_{3,2}y+a_{3,3}x²+a_{3,4}xy+a_{3,5}y²+a_{3,6}x³+a_{3,7}x²y+a_{3,8}xy²+. . . (5)

and corresponding specific gravity distribution equation satisfies a mathematical relational expression below:

γ_{w,x}=γ_{0,x}+a_{4,1}x+a_{4,2}y+a_{4,3}x²+a_{4,4}xy+a_{4,5}y²+a_{4,6}x³+a_{4,7}x²y+a_{4,8}xy²+. . . (6)

γ_{w,y}=γ_{0,y}+a_{5,1}x+a_{5,2}y+a_{5,3}x²+a_{5,4}xy+a_{5,5}y²+a_{5,6}x³+a_{5,7}x²y+a_{5,8}xy²+. . . (7)

in formulas (3)-(7), a_{1,1}-a_{1,8}, a_{2,1}-a_{2,8}, a_{3,1}-a_{3,8}, a_{4,1}-a_{4,8} and a_{5,1}-a_{5,8} are all constant coefficients;

the balance equation of the force satisfies a mathematical relational expression below:

$$\begin{matrix}\frac{\partial {σ}_{xx}}{\partial x} + \frac{\partial {τ}_{xy}}{\partial y} + {γ}_{w , x} = 0 & ( 8 ) \\ \frac{\partial {τ}_{xy}}{\partial x} + \frac{\partial {σ}_{yy}}{\partial y} + {γ}_{w , y} = 0 & ( 9 )\end{matrix}$$

in any coordinates condition, a necessary condition for satisfying the balance equation of the force is that corresponding coefficients each are zero; assuming that specific gravities γ_{w,x} and γ_{w,y} are both constants, the following relational expression may be obtained from formula (8): and

a_{1,1}+a_{3,2}αγ_{0,x}=0 (10)

2a_{1,3}+a_{3,4}=0 (11)

a_{1,4}+2a_{3,5}=0 (12)

3a_{1,6}+a_{3,7}=0 (13)

2a_{1,7}+2a_{3,8}=0 (14)

a_{1,8}+3a_{3,9}=0 (15)

. . .

the following relational expression may be obtained from formula (9):

a_{3,1}+a_{2,2}+γ_{0,y}=0 (16)

2a_{3,3}+a_{2,4}=0 (17)

a_{3,4}+2a_{2,5}=0 (18)

3a_{3,6}+a_{2,7}=0 (19)

2a_{3,7}+2a_{2,8}=0 (20)

a_{3,8}+3a_{2,9}=0 (21)

. . . .

In a class of this embodiment, in 4), there exist two cases below under the effect of boundary condition stress:

4.1) when the stress is continuous, the boundary stress is equal to the boundary condition stress;

when the research object is a two-dimensional geometric configuration, AB, BC, CD and DA are all boundary surfaces, and the boundary stress and boundary condition stress satisfy a relational expression below: σ_{N}^{AB,B}=σ_{N}^{AB}, τ_{N}^{AB,B}=τ_{N}^{AB}, σ_{N}^{BC,B}=σ_{N}^{BC}, τ_{N}^{BC,B}=τ_{N}^{BC}, σ_{N}^{CD,B}=σ_{N}^{CD}, τ_{N}^{CD,B}=τ_{N}^{CD}, σ_{N}^{DA,B}=σ_{N}^{DA}, τ_{N}^{DA,B}=τ_{N}^{DA};

where σ_{N}^{AB,B}, τ_{N}^{AB,B}, σ_{N}^{BC,B}, τ_{N}^{BC,B}, σ_{N}^{CD,B}, τ_{N}^{CD,B}, σ_{N}^{DA,B}τ_{N}^{DA,B} are boundary condition normal stress and boundary condition shear stress of the AB, BC, CD and DA surfaces respectively and σ_{N}^{AB}, τ_{N}^{AB}, σ_{N}^{BC}, τ_{N}^{BC}, σ_{N}^{CD}, τ_{N}^{CD}, σ_{N}^{DA}τ_{N}^{DA} are boundary normal stress and boundary shear stress of the AB, BC, CD and DA surfaces respectively; and

4.2) when the stress is partially discontinuous, the boundary stress is not equal to the boundary condition stress;

a force and a moment generated by the boundary condition stress and a gravity of the research object are kept balanced; when the research object is a two-dimensional geometric configuration and X axis and Y axis are coordinate axes, the force balance in the X-axis direction satisfies a mathematical relational expression below:

∫_{S}_{_{i,x}}_{^{AB,B}}(σ_{N}^{AB,B}+τ_{N}^{AB,B})ds+∫_{S}_{_{i,x}}_{^{BC,B}}(σ_{N}^{BC,B}+τ_{N}^{BC,B})ds+∫_{S}_{_{i,x}}_{^{CD,B}}(σ_{N}^{CD,B}+τ_{N}^{CD,B})ds+∫_{S}_{_{i,x}}_{^{DA,B}}(σ_{N}^{DA,B}+τ_{N}^{DA,B})ds+∫_{S}_{ᵢ}γ_{w,x}dv=0 (22)

the force balance in the Y-axis direction satisfies a mathematical relational expression below:

∫_{S}_{_{i,y}}_{^{AB,B}}(σ_{N}^{AB,B}+τ_{N}^{AB,B})ds+∫_{S}_{_{i,y}}_{^{BC,B}}(σ_{N}^{BC,B}+τ_{N}^{BC,B})ds+∫_{S}_{_{i,y}}_{^{CD,B}}(σ_{N}^{CD,B}+τ_{N}^{CD,B})ds+∫_{S}_{_{i,y}}_{^{DA,B}}(σ_{N}^{DA,B}+τ_{N}^{DA,B})ds+∫_{S}_{ᵢ}γ_{w,y}dv=0 (23)

in formula (22), S_{i,x}^{AB,B}, S_{i,x}^{BC,B}, S_{i,x}^{CD,B} and S_{i,x}^{DA,B} are projections of the AB, BC, CD and DA surfaces in the X-axis direction respectively; in formula (23), S_{i,y}^{AB,B}, S_{i,y}^{BC,B}, S_{i,y}^{CD,B} and S_{i,y}^{DA,B} are projections of the AB, BC, CD and DA surfaces in the Y-axis direction, and Sᵢ is an area of the research object;

a precondition of determining a moment balance equation is to determine a rotation point, analyze a possible rotation manner and determine the coordinates of the rotation point as Z(X_{N},Y_{N}); the moment balance equation satisfies a mathematical relational expression below:

M_{σ}_{_{N}}_{^{AB,B}}+M_{σ}_{_{N}}_{^{BC,B}}+M_{σ}_{_{N}}_{^{CD,B}}+M_{σ}_{_{N}}_{^{DA,B}}+M_{τ}_{_{N}}_{^{AB,B}}+M_{τ}_{_{N}}_{^{BC,B}}+M_{τ}_{_{N}}_{^{CD,B}}+M_{τ}_{_{N}}_{^{DA,B}}+M_{γ}_{_{w,X}}+M_{γ}_{_{w,Y}}=0 (24)

in formula (24), M_{σ}_{_{N}}_{^{AB,B}}, M_{σ}_{_{N}}_{^{BC,B}}, M_{σ}_{_{N}}_{^{CD,B}}, M_{σ}_{_{N}}_{^{DA,B}}, M_{τ}_{_{N}}_{^{AB,B}}, M_{τ}_{_{N}}_{^{BC,B}}, M_{τ}_{_{N}}_{^{CD,B}}, M_{τ}_{_{N}}_{^{DA,B}} are moments generated by the boundary condition normal stress and the boundary condition shear stress of the AB, BC, CD and DA surfaces respectively and M_{γ}_{_{w,X}}, M_{γ}_{_{w,Y}} are moments generated by the specific gravities in the directions of the X axis and the Y axis respectively; and

when the research object is a three-dimensional geometric configuration, Sᵢ is a volume of the research object; and the precondition of determining the moment balance equation is to determine a rotation axis.

In a class of this embodiment, in 4), when the boundary condition stress may also be a concentrated force and the research object is a two-dimensional geometric configuration, the concentrated force is represented by an integral along an arc length of a particular radius or an elliptic arc length of a particular major and minor axis; and when the research object is a three-dimensional geometric configuration, the concentrated force is represented by an integral along a spherical surface of a particular radius or an ellipsoidal surface of a particular major and minor axis.

In a class of this embodiment, in 3), other boundary surfaces of the research object have a feature consistent with that of the AB boundary surface, and formula (1) and formula (2) hold only under the condition of a continuous stress.

In a class of this embodiment, in 5), a corresponding primary stress is calculated based on the acquired theoretical solution of the stress, and substituted into an existing strength criterion to determine a destruction state point, a destruction direction or a destruction surface.

In a class of this embodiment, comparative analysis is performed on a deformation feature of the research object, and a behavior feature of the research object is determined in accordance with corresponding constitutive equation; a corresponding constitutive equation is established by use of existing primary stress-strain relation obtained under a primary stress condition indoors and outdoors so as to obtain a primary strain; and assuming that the rotation of coordinates may be suitable for calculating a strain in any direction, comparative analysis is performed on a field-measured deformation and a deformation derived from the constitutive relationship so as to obtain a deformation behavior feature of the research object.

Benefits:

1. Assuming that a stress of a research object satisfies boundary and balance condition, the solving method of the present disclosure can solve a theoretical solution of a stress distribution feature of the research object in any geometric shape and can also solve the sizes of an absolute stress and a relative stress according to a geometric feature of the research object;

2. The solving method of the present disclosure is applicable to the solving under the condition of a continuous stress as well as a discontinuous stress; and

3. The solving method of the present disclosure promotes research and application of dynamic-static loading/unloading and destruction process of different construction structures such as dams, bridges, slopes, roadbeds, houses, tunnels, inclusions, lanes and culverts, and can obtain corresponding theoretical solutions.

### BRIEF DESCRIPTION OF THE DRAWINGS

FIG. 1 illustrates a schematic diagram of a feature of a boundary stress of the i-th research object according to an example.

FIG. 2 illustrates a schematic diagram of a feature of a boundary condition stress of the i-th research object according to an example.

FIG. 3 illustrates a schematic diagram of a relationship between a normal stress and a rotation point of a boundary condition of the i-th research object according to an example.

FIG. 4 illustrates a schematic diagram of a relationship between a tangential stress and a rotation point of a boundary condition of the i-th research object according to an example.

FIG. 5 illustrates a method of designing protection measures based on stress analysis in example 3 where OADE is a protected object and ABCD is a reinforcing area or a protective measures area such as retaining wall, anti-slide pile, anchor cable or anchor rod.

### DETAILED DESCRIPTION OF THE EMBODIMENTS

To better explain the present disclosure, the main contents of the present disclosure are further set forth below by use of specific examples, but the contents of the present disclosure are not limited to the examples below.

### Example 1

The present example discloses a method of solving a stress based on force boundary and balance condition; and the method of solving a stress includes the following steps:

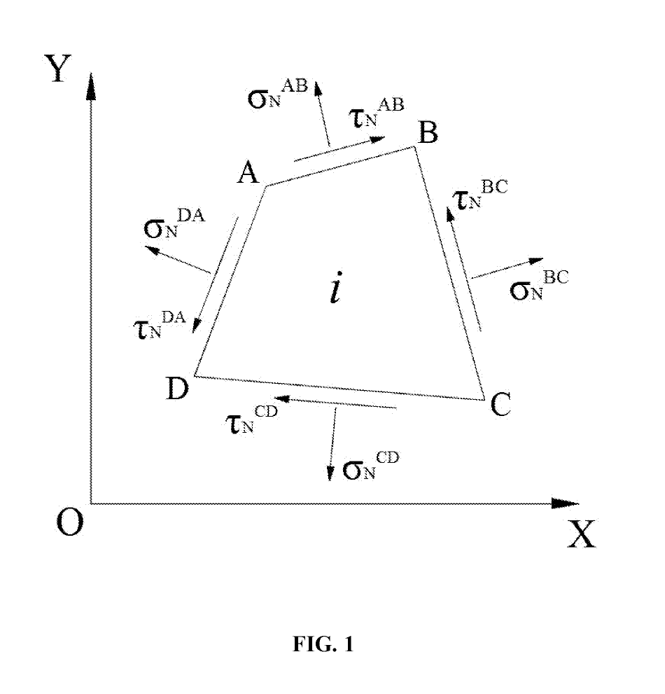

1) establishing corresponding geometric feature description equation based on accurate measurement and research of a research object, where as shown in FIG. 1, the equations corresponding to AB, BC, CD and DA may be represented as y=kx+b (in the case of such forms as a curve and the like, the equations such as a curve may be adopted for representation);

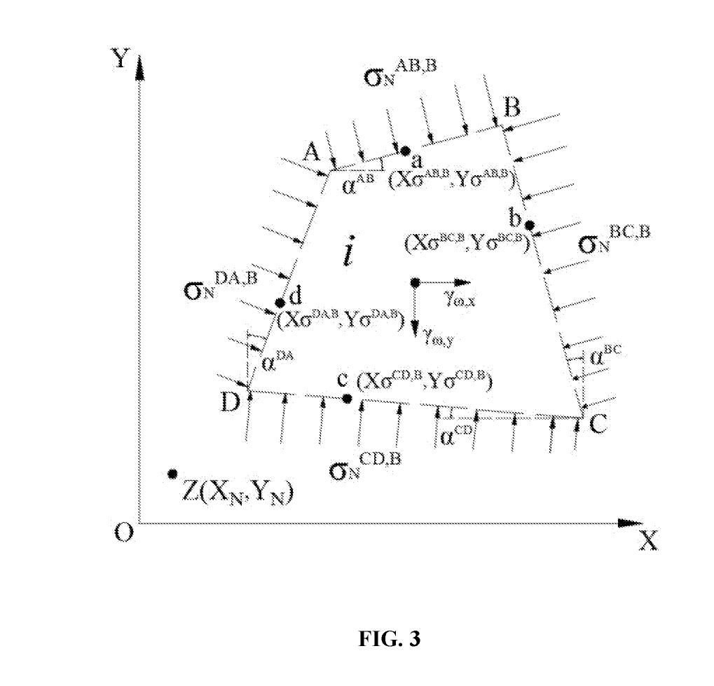

2) establishing a specific gravity distribution equation of the research object in a research area based on the research of a specific gravity distribution feature of the research object, where as shown in FIG. 3, corresponding specific gravities are γ_{w,x}, γ_{w,y} and γ_{w,z};

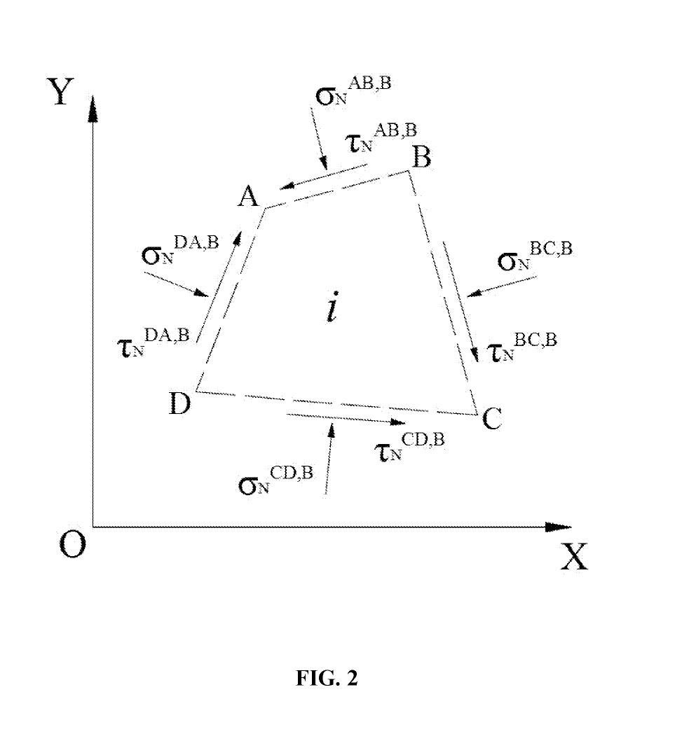

3) establishing corresponding boundary condition stress equation based on the research of a boundary condition stress feature of the research object, where for a two-dimensional problem, the expressions of the boundary normal stress (σ_{N}^{AB,B}) and the boundary tangential stress (τ_{N}^{AB,B}) of an AB surface are determined as follows based on FIG. 2:

σ_{N}^{AB,B}=l²σₓₓ^{AB}+m²σ_{yy}^{AB}+2lmτ_{xy}^{AB} (1)

τ_{N}^{AB,B}=lm(σ_{yy}^{AB}−σₓₓ^{AB})+(l²−m²)τ_{xy}^{AB} (2)

Where, l and m are cosine values in an outer normal direction of the AB surface; and σₓₓ^{AB}, σ_{yy}^{AB} and τ_{xy}^{AB} are boundary normal stress and shear stress of the AB surface. Formula (1) and Formula (2) are relational expressions of the boundary normal and tangential stresses and the boundary condition stress of the AB surface; and under the condition of a continuous stress, the expressions must be able to describe all corresponding boundary condition stresses, as shown in FIG. 3; when the stress is discontinuous, the expressions are false. In addition, the boundaries such as BC, CD and DA all have features consistent with boundary stress and condition stress of the AB surface.

For the boundary condition stress: to solve the stress, the stress corresponding to the research object may be solved with a known boundary stress of two surfaces, three surfaces and the like (for tetrahedron, hexahedron and the like) or two sides, three sides and the like (triangle, quadrangle, pentagon and the like), and the boundary condition stresses of other corresponding surfaces or sides are calculated according to a feature of the solution.

4) selecting an expression equation of a stress to satisfy a corresponding balance equation and a boundary condition equation of a force, and solving corresponding constant coefficients; for a two-dimensional problem, the description is made as follows:

Assuming a stress expression (other expression forms may be adopted) is as follows:

σₓₓ=a_{1,1}x+a_{1,2}y+a_{1,3}x²+a_{1,4}xy+a_{1,5}y²+a_{1,6}x³+a_{1,7}x²y+a_{1,8}xy²+. . . (3)

σ_{yy}=a_{2,1}x+a_{2,2}y+a_{2,3}x²+a_{2,4}xy+a_{2,5}y²+a_{2,6}x³+a_{2,7}x²y+a_{2,8}xy²+. . . (4)

τ_{xy}=a_{3,1}x+a_{3,2}y+a_{3,3}x²+a_{3,4}xy+a_{3,5}y²+a_{3,6}x³+a_{3,7}x²y+a_{3,8}xy²+. . . (5)

Assuming corresponding specific gravity distribution equation is as follows:

γ_{w,x}=γ_{0,x}+a_{4,1}x+a_{4,2}y+a_{4,3}x²+a_{4,4}xy+a_{4,5}y²+a_{4,6}x³+a_{4,7}x²y+a_{4,8}xy²+. . . (6)

γ_{w,y}=γ_{0,y}+a_{5,1}x+a_{5,2}y+a_{5,3}x²+a_{5,4}xy+a_{5,5}y²+a_{5,6}x³+a_{5,7}x²y+a_{5,8}xy²+. . . (7)

In Formula (3) (7), a_{1,1}-a_{1,8}, a_{2,1}-a_{2,8}, a_{3,1}-a_{3,8}, a_{4,1}-a_{4,8} and a_{5,1}-a_{5,8} are all constant coefficients; the finite element of Formula (3)-(7) cycles to i where i is an integer.

A balance equation of a force is satisfied is:

$$\begin{matrix}\frac{\partial {σ}_{xx}}{\partial x} + \frac{\partial {τ}_{xy}}{\partial y} + {γ}_{w , x} = 0 & ( 8 ) \\ \frac{\partial {τ}_{xy}}{\partial x} + \frac{\partial {σ}_{yy}}{\partial y} + {γ}_{w , y} = 0 & ( 9 )\end{matrix}$$

In any coordinate condition, the necessary condition for satisfying the stress balance equation is that corresponding coefficients each are zero; in the case that the specific gravity is a constant (the cases that the specific gravity satisfies formulas (6) and (7) may be studied), then

the following relational expression may be obtained from formula (8):

a_{1,1}+a_{3,2}αγ_{0,x}=0 (10)

2a_{1,3}+a_{3,4}=0 (11)

a_{1,4}+2a_{3,5}=0 (12)

3a_{1,6}+a_{3,7}=0 (13)

2a_{1,7}+2a_{3,8}=0 (14)

a_{1,8}+3a_{3,9}=0 (15)

. . .

the following relational expression may be obtained from formula (9):

a_{3,1}+a_{2,2}+γ_{0,y}=0 (16)

2a_{3,3}+a_{2,4}=0 (17)

a_{3,4}+2a_{2,5}=0 (18)

3a_{3,6}+a_{2,7}=0 (19)

2a_{3,7}+2a_{2,8}=0 (20)

a_{3,8}+3a_{2,9}=0 (21)

. . .

As shown in FIG. 1, for the i-th research object, under the effect of the boundary condition stress (it may be known from FIG. 2 that the force may also be a concentrated force, where the concentrated force may be represented by an integral along an arc length of a particular radius or an elliptic arc length of a particular major and minor axis (for a two-dimensional problem), or by an integral along a spherical surface of a particular radiu or an ellipsoidal surface of a particular major and minor axis (for a three-dimensional problem)), the boundary stress must be equal to the boundary condition stress in the case of a continuous stress; when the stress is partially discontinuous, the corresponding boundary stress and the corresponding boundary condition stress are not equal; however, the force and the moment generated by the boundary condition stress and the gravity of the i-th research object should be balanced, with the equation as follows:

Relationship between the boundary stress and the boundary condition stress:

Under the condition of a continuous stress, there exists a relational expression below: σ_{N}^{AB,B}=σ_{N}^{AB}, τ_{N}^{AB,B}=τ_{N}^{AB}, σ_{N}^{BC,B}=σ_{N}^{BC}, τ_{N}^{BC,B}=τ_{N}^{BC}, σ_{N}^{CD,B}=σ_{N}^{CD}, τ_{N}^{CD,B}=τ_{N}^{CD}, σ_{N}^{DA,B}=σ_{N}^{DA}, τ_{N}^{DA,B}=τ_{N}^{DA}

(σ_{N}^{AB,B}, τ_{N}^{AB,B}, σ_{N}^{BC,B}, τ_{N}^{BC,B}, σ_{N}^{CD,B}, τ_{N}^{CD,B}, σ_{N}^{DA,B}τ_{N}^{DA,B} are boundary condition normal stress and boundary condition shear stress on the AB, BC, CD and DA surfaces respectively while σ_{N}^{AB}, τ_{N}^{AB}, σ_{N}^{BC}, τ_{N}^{BC}, σ_{N}^{CD}, τ_{N}^{CD}, σ_{N}^{DA}τ_{N}^{DA} are boundary normal stress and boundary shear stress on AB, BC, CD and DA surfaces respectively), assuming that the boundary condition stresses of the AB and DA surfaces are known and the stresses are continuous, a correlation coefficient may be determined by use of the condition that the boundary condition stress is equal to the boundary stress. When the stresses are discontinuous, the boundary condition stress is reflected in the balance equation of force and moment.

Force balance equation:

Force balance in X-axis direction:

∫_{S}_{_{i,x}}_{^{AB,B}}(σ_{N}^{AB,B}+τ_{N}^{AB,B})ds+∫_{S}_{_{i,x}}_{^{BC,B}}(σ_{N}^{BC,B}+τ_{N}^{BC,B})ds+∫_{S}_{_{i,x}}_{^{CD,B}}(σ_{N}^{CD,B}+τ_{N}^{CD,B})ds+∫_{S}_{_{i,x}}_{^{DA,B}}(σ_{N}^{DA,B}+τ_{N}^{DA,B})ds+∫_{S}_{ᵢ}γ_{w,x}dv=0 (22)

Force balance in Y-axis direction:

∫_{S}_{_{i,y}}_{^{AB,B}}(σ_{N}^{AB,B}+τ_{N}^{AB,B})ds+∫_{S}_{_{i,y}}_{^{BC,B}}(σ_{N}^{BC,B}+τ_{N}^{BC,B})ds+∫_{S}_{_{i,y}}_{^{CD,B}}(σ_{N}^{CD,B}+τ_{N}^{CD,B})ds+∫_{S}_{_{i,y}}_{^{DA,B}}(σ_{N}^{DA,B}+τ_{N}^{DA,B})ds+∫_{S}_{ᵢ}γ_{w,y}dv=0 (23)

In formulas (22)-(23), S_{i,x}^{AB,B}, S_{i,x}^{BC,B}, S_{i,x}^{CD,B} and S_{i,x}^{DA,B} are projections of the AB, BC, CD and DA surfaces in the X-axis direction respectively; S_{i,y}^{AB,B}, S_{i,y}^{BC,B}, S_{i,y}^{CD,B} and S_{i,y}^{DA,B} are projections of the AB, BC, CD and DA surfaces in the Y-axis direction, and Sᵢ is area (or volume) of the i-th research object;

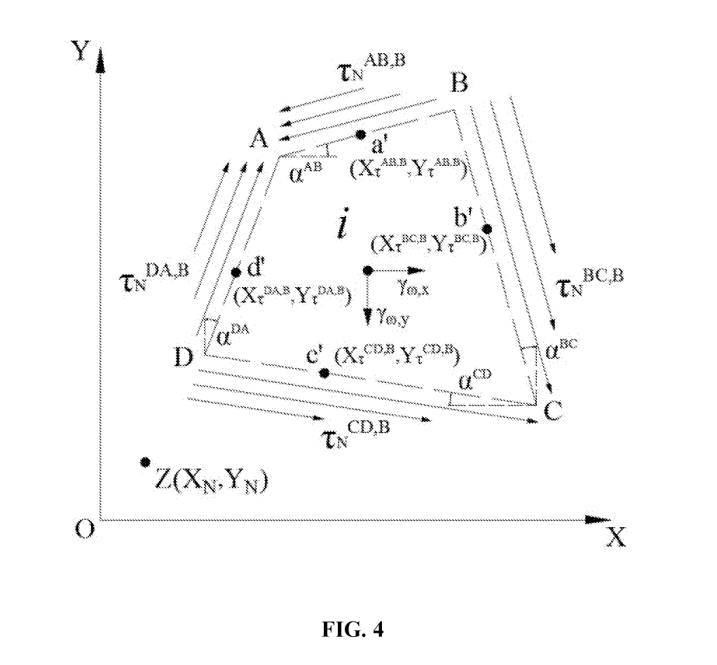

Moment balance: the primary problem of the moment balance equation is to determine a rotation point (for a two-dimensional problem) or a rotation axis (for a three-dimensional problem) and analyze a possible rotation manner to determine the coordinates Z(X_{N}, Y_{N}) of the rotation point; it may be known in combination of FIG. 3 and FIG. 4 that the moment balance equation is as follows:

M_{σ}_{_{N}}_{^{AB,B}}+M_{σ}_{_{N}}_{^{BC,B}}+M_{σ}_{_{N}}_{^{CD,B}}+M_{σ}_{_{N}}_{^{DA,B}}+M_{τ}_{_{N}}_{^{AB,B}}+M_{τ}_{_{N}}_{^{BC,B}}+M_{τ}_{_{N}}_{^{CD,B}}+M_{τ}_{_{N}}_{^{DA,B}}+M_{γ}_{_{w,X}}+M_{γ}_{_{w,Y}}=0 (24)

In formula (24), M_{σ}_{_{N}}_{^{AB,B}}, M_{σ}_{_{N}}_{^{BC,B}}, M_{σ}_{_{N}}_{^{CD,B}}, M_{σ}_{_{N}}_{^{DA,B}}, M_{τ}_{_{N}}_{^{AB,B}}, M_{τ}_{_{N}}_{^{BC,B}}, M_{τ}_{_{N}}_{^{CD,B}}, M_{τ}_{_{N}}_{^{DA,B}} are moments generated by boundary condition normal stress and boundary condition shear stress on the AB, BC, CD and DA surfaces respectively; and M_{γw,X} and M_{γw,Y} are moments generated by specific gravities in the X-axis and Y-axis directions respectively.

According to the steps above, a particular number of constant coefficients may be determined, and thus a theoretical solution of a stress of the research object may be obtained; when the research object is complicated, the whole research object may be divided into several different small objects for solving, but the solution must satisfy the relationships between the stresses and the like of the several different research objects; and

5) According to existing different strength criteria, a stress feature of the research object is analyzed in detail; and comparative analysis may also be performed on a deformation feature of the research object according to corresponding constitutive equation to determine a behavior feature of the research object. Specific analysis steps comprise: calculating the corresponding primary stress based on the theoretical solution of a stress obtained by the above calculation, and substituting the primary stress into existing strength criterion to determine a destruction state point; determining a destruction direction (e.g., MohrCoulomb criterion, Griffth criterion) and a destruction line (for a two-dimensional problem) or surface (for a three-dimensional problem) based on existing strength theory, for a destruction problem, there exists a destruction driving force that is greater than corresponding resistance, i.e., the stress is discontinuous, thus a displacement is also discontinuous; and for the problem of discontinuity, the corresponding stress is solved again according to the steps (1)-(4), and a destruction trajectory may further be determined step by step. To solve a displacement, for the problem of a continuous stress, corresponding primary strain is calculated by use of the primary stress according to the constitutive equation that is based on primary stress; assuming that the rotation of coordinates is suitable for calculating strain in any direction, for discontinuous strain and stress, corresponding discontinuous strain and stress are calculated according to a deformation feature. According to the above steps, theoretical solutions of stress and strain of the destruction process of the whole research object may be obtained and may be compared with on-site state of the research object to correct different theoretical physical and mechanical parameters.

### Example 2

In this example, there is provided a method of reinforcing or protecting a material or structure. Stress features and ground stress measurement are applied based on a force boundary condition, a force balance condition, and reinforcing or protecting measures to carry out reinforcing design for the material or structure where the ground stress measurement is to obtain a ground stress by ground stress measurement sensor.

Taking a two-dimensional slope for example, the blocks are as follows:

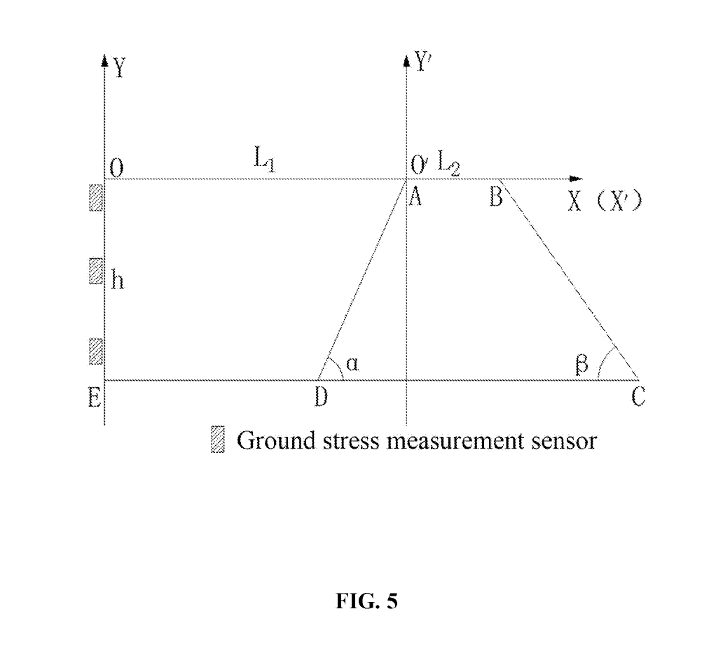

At block 1, existing features of a protected object are determined based on two dimensional theoretical research, numerical value analysis (for example, existing infinite element method, discrete element method and so on) and field determination, and macro-geometric features of the protected object are measured and a geometric expression equation corresponding to the macro-geometric features is established. For example, as shown in FIG. 5, OA, AB, BC, CD, AD, DE, EO is a straight-line equation (for the straight line BC: y=K_{BC}x+b_{BC} and K_{BC}, b_{BC} are slope and intercept respectively).

At block 2, the research object is a two dimensional geometric configuration and thus the specific gravities of the research area including the specific gravity γ_{w,x} of X axis direction and the specific gravity γ_{w,y} of Y axis direction are expressed by the following equations (they may also be expressed in other forms):

γ_{w,x}=γ_{0,x}+a_{4,1}x+a_{4,2}y+a_{4,3}x²+a_{4,4}xy+a_{4,5}y²+a_{4,6}x³+a_{4,7}x²y+a_{4,8}xy²+. . . (25)

γ_{w,y}=γ_{0,y}+a_{5,1}x+a_{5,2}y+a_{5,3}x²+a_{5,4}xy+a_{5,5}y²+a_{5,6}x³+a_{5,7}x²y+a_{5,8}xy²+. . . (26)

where γ_{w,i}ϵ(x, y) are specific gravities of X and Y axes respectively and a_{k,m}, kϵ(4,5), mϵ(1,∞) are constant coefficients respectively where the constant coefficients are determined based on the distribution of the specific gravity of field materials.

At block 3, the existing features such as existing completeness and local damage are determined for a protected object based on the field determination. The boundary condition is determined comprehensively in combination with subsequent possible damage mode of the protected object (i.e. subsequent possible damage feature and development direction) and boundary stress features of applied protective measures so that the boundary condition stress equation is established.

The boundary condition: for a boundary OA, there may be as follows:

y=0: σₓₓ|_{y=0}=0,σ_{yy}|_{y=0}=0,τ_{xy}|_{y=0}=0 (27)

where σₓₓ, σ_{yy}, τ_{xy} are stresses of the area OADE.

For the boundary BC, according to Saint Venant's Principle, there may be as follows:

$${\int }_{BC} {σ}_{{x}^{′} {x}^{′}} dl = 0 , \\ {\int }_{BC} {σ}_{{y}^{′} {y}^{′}} dl = 0 , \\ {\int }_{BC} {τ}_{{x}^{′} {y}^{′}} dl = 0 \qquad ( 28 )$$

where σₓₓ, σ_{yy}, τ_{xy} are stresses of the area ABCD and l is an integral length of BC.

For the boundary AB, according to Saint Venant's Principle, there may be as follows:

y′=0,σ_{x′x′}|_{y′=0},τ_{x′y′}|_{y′=0},∫_{X′}_{_{B}}^{X′}^{_{A}}σ_{y′y′}|_{y′=0}dx′=0 (29)

For the boundary OE, the boundary stress is a far-field stress and its stress value may be obtained by far-field ground stress measurement sensor as shown in FIG. 5.

At block 4, the protected object may be firstly divided into OADE protection area and ABCD protective measures area (i.e. reinforcing measures area) based on material features to form two different calculation areas, i.e. two coordinate systems xoy and x′o′y′. The two coordinate systems are continued by coordinate translation. Non-damaged substances satisfy stress continuity condition in the connection of different substances in the two coordinate systems.

At block 5, for the calculation area OADE, the following stress expressions are selected:

σₓₓ=a_{1,1}x+a_{1,2}y+a_{1,3}x²+a_{1,4}xy+a_{1,5}y²+a_{1,6}x³+a_{1,7}x²y+a_{1,8}xy²+a_{1,9}y³+a_{1,10}x⁴+a_{1,11}x³y+a_{1,12}x²y²+a_{1,13}xy³+a_{1,14}y⁴ (30)

σ_{yy}=a_{2,1}x+a_{2,2}y+a_{2,3}x²+a_{2,4}xy+a_{2,5}y²+a_{2,6}x³+a_{2,7}x²y+a_{2,8}xy²+a_{2,9}y³+a_{2,10}x⁴+a_{2,11}x³y+a₂₁₂x²y²+a_{2,13}xy³+a_{2,14}y⁴ (31)

τ_{xy}=a_{3,1}x+a_{3,2}y+a_{3,3}x²+a_{3,4}xy+a_{3,5}y²+a_{3,6}x³+a_{3,7}x²y+a_{3,8}xy²+a_{3,9}y³+a_{3,10}x⁴+a_{3,11}x³y+a_{3,12}x²y²+a_{3,13}xy³+a_{3,14}y⁴ (32)

where σₓₓ, σ_{yy}, τ_{xy} are normal stress and shear stress respectively and a_{i,j}, iϵ(1,3), jϵ(1,14) are constant coefficients. The equations (25, 26, 30, 31, 32) must satisfy balance equation.

$$\{ \begin{matrix}\frac{\partial {σ}_{xx}}{\partial x} + \frac{\partial {τ}_{xy}}{\partial y} = 0 \\ \frac{\partial {τ}_{xy}}{\partial x} + \frac{\partial {σ}_{yy}}{\partial y} + {γ}_{w , y} = 0\end{matrix} \qquad ( 33 )$$

For the calculation area ABCD, the following stress expressions are selected:

σ_{x′x′}=b_{1,1}x′+b_{1,2}y′+b_{1,3}x′²+b_{1,4}x′y′+b_{1,5}y′²+b_{1,6}x′³+b_{1,7}x′²y′+b_{1,8}x′y′²+b_{1,9}y′³+b_{1,10}x′⁴+b_{1,11}x′³y′+b_{1,12}x′²y′²+b_{1,13}x′y′³+b_{1,14}y′⁴ (34)

σ_{y′y′}=b_{2,1}x′+b_{2,2}y′+b_{2,3}x′²+b_{2,4}x′y′+b_{2,5}y′²+b_{2,6}x′³+b_{2,7}x′²y′+b_{2,8}x′y′²+b_{2,9}y′³+b_{2,10}x′⁴+b_{2,11}x′³y′+b_{2,12}x′²y′²+b_{2,13}x′y′³+b_{2,14}y′⁴ (35)

τ_{x′y′}=b_{3,1}x′+b_{3,2}y′+b_{3,3}x′²+b_{3,4}x′y′+b_{3,5}y′²+b_{3,6}x′³+b_{3,7}x′²y′+b_{3,8}x′y′²+b_{3,9}y′³+b_{3,10}x′⁴+b_{3,11}x′³y′+b_{3,12}x′²y′²+b_{3,13}x′y′³+b_{3,14}y′⁴ (36)

where, σ_{x′,x′}, σ_{y′y′}, τ_{x′,y′}, are normal stress and shear stress respectively and b_{i,j}, iϵ(1,3), jϵ(1,14) are constant coefficients.

The specific gravity equation corresponding to the calculation area ABCD_{may} be expressed in a form similar to the equation (25, 26), that is:

γ_{w,x′}=γ_{0,x′}+b_{4,1}x′+b_{4,2}y′+b_{4,3}x′²+b_{4,4}x′y′+b_{4,5}y′²+b_{4,6}x′³+b_{4,7}x′²y′+b_{4,8}x′y′²+. . . (37)

γ_{w,y′}=γ_{0,y′}+b_{5,1}x′+b_{5,2}y′+b_{5,3}x′²+b_{5,4}x′y′+b_{5,5}y′²+b_{5,6}x′³+b_{5,7}x′²y′+b_{5,8}x′y′²+. . . (38)

where, γ_{w,i}′, iϵ(x′, y′) are the specific gravities of X′ and Y′ directions and b_{k,m}, kϵ(4,5), mϵ(1,∞) are constant coefficients respectively where the constant coefficients are determined based on the specific gravity distribution of the field materials, i.e. the materials in the area ABCD

Similarly, the equations (34, 35, 36, 37, 38) must also satisfy the balance equation. Corresponding different parameters may be determined based on the above boundary condition so as to obtain the stress distributions of the protection area OADE and the reinforcing area ABCD.

At block 6, analysis is performed for the stress field of the calculation area, i.e the protection area OADE and the stress state of each point is analyzed according to existing peak strength rule (such as Mohr-Coulomb Rule, Hoek-Brown Rule, Druck Prager Rule, and Griffith Rule) so as to determine the state of each point such as elasticity, damage, or destruction. The materials of reinforcing area ABCD are selected to calculate deformation features of the reinforcing area and the impact of the deformation behavior on the stress of the protection area according to different physical mechanic parameters, the configuration theory and the configuration parameters so that the reinforcing methods of the reinforcing area may be determined reasonably, such as anti-slide pile, retaining wall, anchor rod, anchor cable, soil nail, protection wedge, and crack tip passivation and corresponding reinforcing material type, sectional size, and reinforcement ratio, and a new reinforcing strength criteria and a new permanent displacement criteria are formed.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method of solving a stress based on force boundary and balance condition, the method comprising:
1) measuring a macro-geometric feature of a research object, and establishing a geometric feature description equation corresponding to the macro-geometric feature;
2) analyzing a specific gravity distribution feature of the research object, and establishing a specific gravity distribution equation of the research object in a research area;
3) analyzing a feature of boundary condition stress of the research object, and establishing a boundary condition stress equation corresponding to the feature of boundary condition stress;
4) selecting a stress expression equation wherein the stress expression equation satisfies corresponding balance equation and a boundary condition equation of a force, and all constant coefficients are calculated; and
5) analyzing a stress feature of the research object in detail according to an existing strength criterion; and performing comparative analysis on a deformation feature of the research object, and determining a behavior feature of the research object according to corresponding constitutive equation.

2. The method of claim 1, wherein
a corresponding geometric feature description equation is established based on accurate measurement and research of the research object in 1), the geometric feature description equation comprises a linear equation or a nonlinear equation, the linear equation is represented as y=kx+b and the nonlinear equation comprises a curve equation;
the specific gravity distribution equation of the research object in the research area is established based on the research of the specific gravity distribution feature of the research object in 2), wherein a specific gravity corresponding to the specific gravity distribution equation comprises γ_{w,x}, γ_{w,y}, γ_{w,z};
a corresponding boundary stress equation is established based on feature research of boundary condition stress of the research object, in 3); wherein when the research object is a two-dimensional geometric configuration, in case that AB is a boundary surface, a normal stress of the boundary condition of an AB surface is σ_{N}^{AB,B}, a shear stress of the boundary condition of the AB surface is τ_{N}^{AB,B}, and a mathematical relational expression below is satisfied:
σ_{N}^{AB,B}=l²σₓₓ^{AB}+m²σ_{yy}^{AB}+2lmτ_{xy}^{AB} (1)
τ_{N}^{AB,B}=lm(σ_{yy}^{AB}−σₓₓ^{AB})+(l²−m²)τ_{xy}^{AB} (2)
in formula (1) and formula (2), 1 and m are cosine values in an outer normal direction of the AB surface; σxxAB and σyyAB are normal stresses and τxyAB is a shear stress;
a stress expression equation is selected in 4) wherein the stress expression equation satisfies corresponding balance equation of a force and a corresponding boundary condition equation of a force, and each of corresponding constant coefficients is thus solved;
when the research object is a two-dimensional geometric configuration, a stress comprises normal stresses axx and ayy and shear stress Txy; when an expression of the stress satisfies a mathematical relational expression below:
σₓₓ=a_{1,1}x+a_{1,2}y+a_{1,3}x²+a_{1,4}xy+a_{1,5}y²+a_{1,6}x³+a_{1,7}x²y+a_{1,8}xy²+. . . (3)
σ_{yy}=a_{2,1}x+a_{2,2}y+a_{2,3}x²+a_{2,4}xy+a_{2,5}y²+a_{2,6}x³+a_{2,7}x²y+a_{2,8}xy²+. . . (4)
τ_{xy}=a_{3,1}x+a_{3,2}y+a_{3,3}x²+a_{3,4}xy+a_{3,5}y²+a_{3,6}x³+a_{3,7}x²y+a_{3,8}xy²+. . . (5)
and corresponding specific gravity distribution equation satisfies a mathematical relational expression below:
γ_{w,x}=γ_{0,x}+a_{4,1}x+a_{4,2}y+a_{4,3}x²+a_{4,4}xy+a_{4,5}y²+a_{4,6}x³+a_{4,7}x²y+a_{4,8}xy²+. . . (6)
γ_{w,y}=γ_{0,y}+a_{5,1}x+a_{5,2}y+a_{5,3}x²+a_{5,4}xy+a_{5,5}y²+a_{5,6}x³+a_{5,7}x²y+a_{5,8}xy²+. . . (7)
in formulas (3)-(7), a1,1-a1,8, a2,1-a2,8, a3,1-a3,8, a4,1-a4,8 and a5,1-a5,8 are all constant coefficients;
the balance equation of the force satisfies a mathematical relational expression below:
$$\begin{matrix}\frac{\partial {σ}_{xx}}{\partial x} + \frac{\partial {τ}_{xy}}{\partial y} + {γ}_{w , x} = 0 & ( 8 ) \\ \frac{\partial {τ}_{xy}}{\partial x} + \frac{\partial {σ}_{yy}}{\partial y} + {γ}_{w , y} = 0 & ( 9 )\end{matrix}$$
in any coordinates condition, a necessary condition for satisfying the balance equation of the force is that corresponding coefficients each are zero; assuming that specific gravities yw,x and yw,y are both constants, the following relational expression is obtained from formula (8): and
a_{1,1}+a_{3,2}αγ_{0,x}=0 (10)
2a_{1,3}+a_{3,4}=0 (11)
a_{1,4}+2a_{3,5}=0 (12)
3a_{1,6}+a_{3,7}=0 (13)
2a_{1,7}+2a_{3,8}=0 (14)
a_{1,8}+3a_{3,9}=0 (15)
. . .
the following relational expression is obtained from formula (9):
a_{3,1}+a_{2,2}+γ_{0,y}=0 (16)
2a_{3,3}+a_{2,4}=0 (17)
a_{3,4}+2a_{2,5}=0 (18)
3a_{3,6}+a_{2,7}=0 (19)
2a_{3,7}+2a_{2,8}=0 (20)
a_{3,8}+3a_{2,9}=0 (21)
. . . .

3. The method of claim 2, wherein
in 4), there exist two cases below under the effect of boundary condition stress:
4.1) when the stress is continuous, the boundary stress is equal to the boundary condition stress;
when the research object is a two-dimensional geometric configuration, AB, BC, CD and DA are all boundary surfaces, and the boundary stress and boundary condition stress satisfy a relational expression below:
σ_{N}^{AB,B}=σ_{N}^{AB},τ_{N}^{AB,B}=τ_{N}^{AB},σ_{N}^{BC,B}=σ_{N}^{BC},τ_{N}^{BC,B}=τ_{N}^{BC},σ_{N}^{CD,B}=σ_{N}^{CD},τ_{N}^{CD,B}=τ_{N}^{CD},σ_{N}^{DA,B}=σ_{N}^{DA},τ_{N}^{DA,B}=τ_{N}^{DA};
where σ_{N}^{AB,B}, τ_{N}^{AB,B}, σ_{N}^{BC,B}, τ_{N}^{BC,B}, σ_{N}^{CD,B}, τ_{N}^{CD,B}, σ_{N}^{DA,B}τ_{N}^{DA,B} are boundary condition normal stress and boundary condition shear stress of the AB, BC, CD and DA surfaces respectively and σ_{N}^{AB}, τ_{N}^{AB}, σ_{N}^{BC}, τ_{N}^{BC}, σ_{N}^{CD}, τ_{N}^{CD}, σ_{N}^{DA}τ_{N}^{DA} are boundary normal stress and boundary shear stress of the AB, BC, CD and DA surfaces respectively; and
4.2) when the stress is partially discontinuous, the boundary stress is not equal to the boundary condition stress:
a force and a moment generated by the boundary condition stress and a gravity of the research object are kept balanced; when the research object is a two-dimensional geometric configuration and X axis and Y axis are coordinate axes, the force balance in the X-axis direction satisfies a mathematical relational expression below:
∫_{S}_{_{i,x}}_{^{AB,B}}(σ_{N}^{AB,B}+τ_{N}^{AB,B})ds+∫_{S}_{_{i,x}}_{^{BC,B}}(σ_{N}^{BC,B}+τ_{N}^{BC,B})ds+∫_{S}_{_{i,x}}_{^{CD,B}}(σ_{N}^{CD,B}+τ_{N}^{CD,B})ds+∫_{S}_{_{i,x}}_{^{DA,B}}(σ_{N}^{DA,B}+τ_{N}^{DA,B})ds+∫_{S}_{ᵢ}γ_{w,x}dv=0 (22)
the force balance in the Y-axis direction satisfies a mathematical relational expression below:
∫_{S}_{_{i,y}}_{^{AB,B}}(σ_{N}^{AB,B}+τ_{N}^{AB,B})ds+∫_{S}_{_{i,y}}_{^{BC,B}}(σ_{N}^{BC,B}+τ_{N}^{BC,B})ds+∫_{S}_{_{i,y}}_{^{CD,B}}(σ_{N}^{CD,B}+τ_{N}^{CD,B})ds+∫_{S}_{_{i,y}}_{^{DA,B}}(σ_{N}^{DA,B}+τ_{N}^{DA,B})ds+∫_{S}_{ᵢ}γ_{w,y}dv=0 (23)
in formula (22), Si,xAB,B, Si,xBC,B, Si,xCD,B and Si,xDA,B are projections of the AB, BC, CD and DA surfaces in the X-axis direction respectively; in formula (23), Si,yAB,B, Si,yBC,B, Si,yCD,B and Si,yDA,B are projections of the AB, BC, CD and DA surfaces in the Y-axis direction, and Si is an area of the research object;
a precondition of determining a moment balance equation is to determine a rotation point, analyze a possible rotation manner and determine the coordinates of the rotation point as Z(XN,YN); the moment balance equation satisfies a mathematical relational expression below:
M_{σ}_{_{N}}_{^{AB,B}}+M_{σ}_{_{N}}_{^{BC,B}}+M_{σ}_{_{N}}_{^{CD,B}}+M_{σ}_{_{N}}_{^{DA,B}}+M_{τ}_{_{N}}_{^{AB,B}}+M_{τ}_{_{N}}_{^{BC,B}}+M_{τ}_{_{N}}_{^{CD,B}}+M_{τ}_{_{N}}_{^{DA,B}}+M_{γ}_{_{w,X}}+M_{γ}_{_{w,Y}}=0 (24)
in formula (24), M_{σ}_{_{N}}_{^{AB,B}}, M_{σ}_{_{N}}_{^{BC,B}}, M_{σ}_{_{N}}_{^{CD,B}}, M_{σ}_{_{N}}_{^{DA,B}}, M_{τ}_{_{N}}_{^{AB,B}}, M_{τ}_{_{N}}_{^{BC,B}}, M_{τ}_{_{N}}_{^{CD,B}}, M_{τ}_{_{N}}_{^{DA,B}} are moments generated by the boundary condition normal stress and the boundary condition shear stress of the AB, BC, CD and DA surfaces respectively and M_{γ}_{_{w,X}}, M_{γ}_{_{w,Y}} are moments generated by the specific gravities in the directions of the X axis and the Y axis respectively; and
when the research object is a three-dimensional geometric configuration, Si is a volume of the research object; and the precondition of determining the moment balance equation is to determine a rotation axis.

4. The method of claim 2, wherein in 4), when the boundary condition stress is a concentrated force and the research object is a two-dimensional geometric configuration, the concentrated force is represented by an integral along an arc length of a particular radius or an elliptic arc length of a particular major and minor axis; and when the research object is a three-dimensional geometric configuration, the concentrated force is represented by an integral along a spherical surface of a particular radius or an ellipsoidal surface of a particular major and minor axis.

5. The method of claim 2, wherein in 3), other boundary surfaces of the research object have a feature consistent with that of the AB boundary surface, and formula (1) and formula (2) hold only under the condition of a continuous stress.

6. The method of claim 1, wherein in 5), a corresponding primary stress is calculated based on the acquired theoretical solution of the stress, and substituted into an existing strength criterion to determine a destruction state point, a destruction direction or a destruction surface.

7. The method of claim 1, wherein comparative analysis is performed on a deformation feature of the research object, and a behavior feature of the research object is determined in accordance with corresponding constitutive equation; a corresponding constitutive equation is established by use of existing primary stress-strain relation obtained under a primary stress condition indoors and outdoors so as to obtain a primary strain; and assuming that the rotation of coordinates is suitable for calculating a strain in any direction, comparative analysis is performed on a field-measured deformation and a deformation derived from the constitutive relationship to obtain a deformation behavior feature of the research object.
